(19) United States
(12) Patent Application Publication
(10) Pub. No.: US 2005/0200051 A1
(43) Pub. Date: Sep. 15, 2005

(54) Method and apparatus for molding a composite modular tile with edge interlocks

(75) Inventors: Thomas E. Ricciardelli, Hingham, MA (US); Robert J. Bergeson, Buzzards Bay, MA (US)

Correspondence Address: Jerry M. Presson, 95 Golden Hill Road, Trumbull, CT, 06611, US

(73) Assignee: SelecTech Inc., Taunton, MA (US)

(21) Appl. No.: 10/797,316

(22) Filed: Mar. 9, 2004

(51) Int. Cl. B29C 45/14

(52) U.S. Cl. 264/511; 425/116; 264/259

(57) ABSTRACT

A method and apparatus for producing a tile that includes a preformed plastic lamina thermally bonded to a planar plastic tile substrate. The tile has edge interlock elements formed thereon. The thermal bonding is accomplished during an injection molding process utilized to mold the substrate. Placement of the lamina in the apparatus for thermal bonding is controlled by a robotic arm.

### BACKGROUND

1. Field of the Invention

This invention relates to a method of, and an apparatus for, molding a composite modular plastic tile with edge interlock elements, and more particularly, to a method and apparatus for molding a composite polymeric tile comprised of a planar substrate and a preformed lamina covering the substrate wherein the lamina is bonded to the substrate during the formation process.

2. Background Discussion

The process of plastic injection molding employing an injection molding machine is a conventional process for molding modular polymeric floor tiles with exposed edge male-female interlock elements on all edges thereof, as disclosed, for example, in U.S. Pat. No. 6,303,318 to Ricciardelli et al., assigned to the same assignee as the instant invention. As illustrated in FIG. 1 of that patent, the interlocks on one pair of tile edges being designed as substantially identical inverted images of those on another pair of transversely opposed tile edges, the interlocks of contiguous floor tiles may be locked together without the use of adhesives; the resilient interlocking advantageously constituting the sole inter-tile connective means. The interlock elements rely upon their design tolerances and resiliency for connective integrity.

As disclosed in U.S. Pat. No. 6,303,318, the tile may be composed of a material of recycled, granulated carpet fiber and carpet backing material to which a polymeric plasticizer is added to increase molding plasticity and product resiliency prior to the feeding of the matrix in molten form into the closed and co-acting mold halves of a two-cavity injection molding machine. As disclosed in the '303 patent, this granulated material is primarily composed of polyvinyl chloride that can be readily molded under the heat and pressure available in a two-cavity injection molding machine. Polyvinyl chloride tiles have been produced by such machines which are typically comprised of horizontally aligned respective fixed and movable mold platens having horizontally aligned cavities therein for respectively molding the lower and upper portions of the tile after being driven together, held closed and fed molten plastic. The molten plastic matrix material is typically injected into the fixed plastic platen half of the injection molding machine by an extruder at a temperature of approximately between 100-400 degrees Celsius, and preferably at a temperature of approximately between 125-175 degrees Celsius and most preferably at a temperature of approximately 150 degrees Celsius and subjected to a pressure of between 1,200 and 1,500 pounds per square inch (PSI). The extruder is arranged to provide material to the closed mold cavity and molds the tile with exposed interlocks on all edges. Coolant material, having a temperature of approximately between 20-60 degrees Celsius, and preferably about 40 degrees Celsius, is transferred through coolant tubes that are embedded in the fixed platen to accelerate solidification of the matrix prior to opening the movable mold and the subsequent removal of the completely molded tile.

The operation involving the opening and closing of the movable platen half is controlled by bi-directional valves coupled to a hydraulic cylinder having an internal, translatable piston with its piston rod connected to an end of the movable platen opposite its cavity face. The drive force applied by the hydraulic cylinder to the movable platen to hold the two platens in abutment and the mold cavity closed during injection of the molten matrix therein typically approximates 200 tons. The mold cavity in the movable platen is typically designed to mold the top surface portion and a minor thickness proportion of the tile that may be embossed with a pattern of coin-like protrusions to provide the tile with greater slip resistance. Conversely, the fixed platen is typically designed to mold the remaining portion of the tile body, and both platens incorporate opposed contacting edgings of interlock molding elements for molding there-between the alternating male and female edge interlock elements on all of the tile edges.

As will be apparent, plastic tiles may be fabricated of recycled materials utilizing waste scrap that would otherwise likely be deposited in landfills, and therefore, it is advantageous solely from an environmental viewpoint to provide greater user acceptability of these products. By adhering, for example, a decorative, additional surface lamina on the tile, acceptability of the tile for various flooring applications is likely to be increased.

Conventional processes for adhering a lamina onto a plastic substrate involves the process of laminating the preformed plastic tile components; one example is a planar base or substrate component and the second, a top lamina appropriately colored or otherwise utilization-enhanced plastic sheet. The two performs are typically laminated together by applying heat and pressure to the superimposed components comprising the composite tile sufficient to effect thermal adhesion therebetween. Since adhesion is required between the opposing and interior surfaces of the previously molded substrate and lamina, the prior art processes are inherently inefficient because they require tile reapplication of external heat and pressure to both component members for a period sufficient to heat and soften the interfacing surfaces of both to achieve adhesion.

### SUMMARY OF THE INVENTION

In accordance with this invention, the method of this invention is implemented by a two-platen injection molding apparatus having open and closed sides; the first platen being stationary and the second platen being drivable against and away from the first platen. The second platen incorporates a second mold cavity half with an inwardly recessed pocket portion that is sized and shaped to receive and position a lamina component there on with the platens open. The first platen incorporates a first cavity half aligned opposite the second cavity and recessed to mold the underlying substrate component from molten polymeric material that is injected into the first cavity.

The mold platens are constructed to provide two pairs of interlock element molding strips; one pair being a substantially identical mirror image of the other with the interlock molding elements of the one pair of strips projecting toward the plane of the lamina and the molding elements of the other pair of strips projecting away from that plane.

With the platens and their cavities driven closed, molten substrate material is injected into the fixed, first cavity and is directed against the lamina surface facing that cavity to effect a thermal bonding therewith and the substantially simultaneous formation of the interlock element pairs on the substrate around the lamina edges.

In accordance with one embodiment of the invention, placement of lamina in the second movable mold and removal of the laminated composite from the first, fixed mold is performed by a robotic arm that is movable between the open platens.

Accordingly, another embodiment of the present invention is directed to an injection molding apparatus for making a modular interlocking composite plastic tile of a substrate with preformed planar plastic lamina laminated thereto, comprising:
first and second co-actable mold platens having substantially planar faces mounted in substantially parallel and opposed relationship,
means for fixedly mounting the first platen,
drive means for driving the second platen toward and away from said first fixed platen,
first and second open-ended mold cavities recessed in the faces of said first and second platens respectively for molding bottom and top portions of the tile substrate, respectively,
said cavities having open ends aligned substantially opposite one another for forming an enclosed mold when the face of said second platen is driven into abutting relationship with the face of said first platen by the said drive means, each of said cavities having a substantially planar base substantially parallel to and inwardly of the planes of a corresponding one of the platen faces and first, second, third, and fourth substantially rectangular sidewalls adjoining corresponding first and second one of the cavity bases and extending substantially perpendicularly therefrom toward the plane of a corresponding platen,
said first and second sidewalls disposed at substantially right angles with respect to each other and intersecting to form a first interior corner region in each of their respective cavities, and said third and fourth sidewalls disposed at substantially right angles with respect to each other and intersecting to form a second transversely opposite interior corner region in each of their respective cavities, a pair of first elongated interlock element molding strips each formed in the platen face of said first platen adjacent the first and second sidewalls, respectively, of said first platen, and positioned opposite said second cavity laterally inwardly of the first and second sidewalls thereof, respectively, for molding a first pair of substantially right-angled substrate edges and contiguous portions of the substrate in the first corner region of the first cavity,
a pair of second elongated interlock element molding strips each formed in the platen face of said second platen laterally outwardly of said third and fourth sidewalls respectively, of said second platen and projecting towards the plane of said first platen face for molding therebetween a second pair of substantially right-angled substrate edges and contiguous portions of the substrate laterally outwardly of said second corner region of said second cavity,
the first and second pairs of molding element strips having respective substantially identical, inverted patterns of edge interlock elements thereon, the corner regions of said second cavity being spaced to receive and position plastic lamina in said second cavity in an orientation substantially parallel to the plane of said second mold platen, and
conduit means coupled to said first platen and communicating with said first cavity for feeding molten substrate plastic for the tile substrate into said closed mold, whereby the substrate is molded and the lamina adhered thereto during substrate molding.

### BRIEF DESCRIPTION OF THE DRAWINGS

The following is a brief description of the drawings that form a part of this disclosure in which:

FIG. 1 shows a top plan view of one embodiment of the composite tile constructed by the method and apparatus of the invention;

FIG. 2 shows a bottom plan view of the tile illustrated in FIG. 1.

FIG. 3 shows a schematic diagram of a flow chart of the process of the present invention.

FIG. 4 is a side sectional elevation view of a schematic drawing of an embodiment of a prior art injection molding apparatus for molding a prior art style of floor tile.

FIG. 5 shows a partial sectional side elevation view of a schematic drawing illustrating an embodiment of the preferred apparatus of this invention.

FIG. 6 shows a partial side view elevation view of the apparatus of this invention showing the platen halves in a closed state for molding a tile.

FIG. 7 shows a frontal plan view of the cavity mold of the movable platen half of the apparatus of this invention, with certain non-pertinent parts omitted for clarity.

FIG. 8 is a partial sectional side elevation of the lower part of the open mold with a preform positioned therein.

FIG. 9 is a partial sectional side elevation view of the upper part of the open mold with a preform positioned therein.

FIG. 10 is a frontal plan view of the cavity mold of the fixed platen half, with certain non-pertinent parts omitted for clarity.

FIG. 11 shows another embodiment of a preform positioned in the movable cavity shown in FIG. 9.

### DETAILED DESCRIPTION OF THE INVENTION

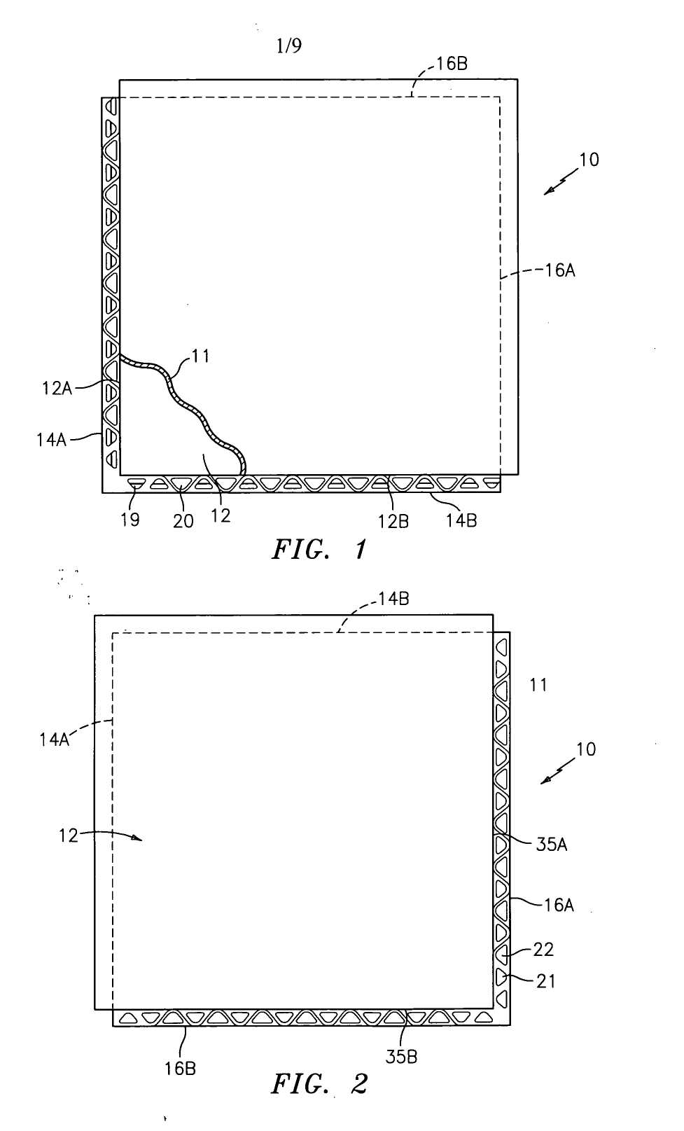

FIGS. 1 and 2 show one embodiment of a tile 10 of generally square shape with two pairs of interlocking edges constructed as disclosed in co-pending U.S. Patent Application Docket NO. 2601.105, by John P. Vanderhoef, entitled, “Interlocking Tile”, filed Jan. 30, 2004, that application being assigned to the assignee of the present invention and is hereby incorporated by reference in its entirety herein.

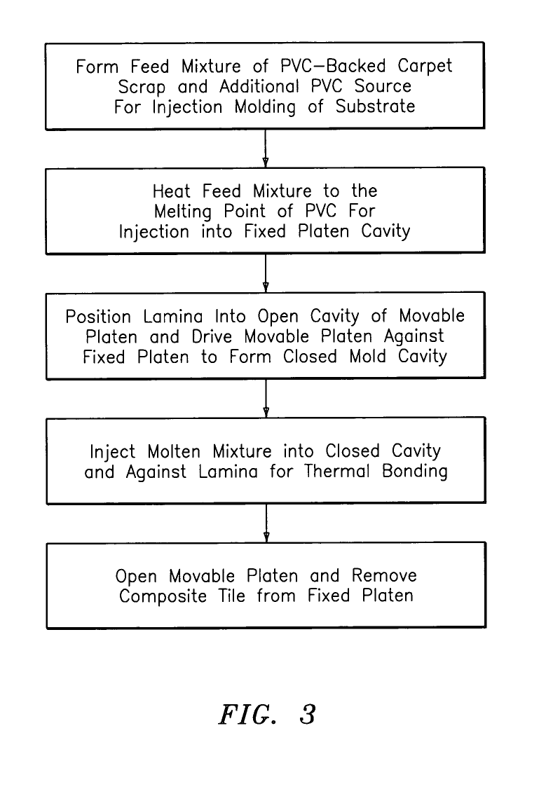

The tile 10 is a layered composite comprised of a planer lamina upper portion 11 that is superimposed upon a generally planar and parallel lower portion, or substrate, 12. The substrate 12 has a generally smooth upper surface. The substrate 12, is molded with a first and a second pair of the interlock-configured edge strips 14A, 14B and 16A, 16B, respectively, extending laterally outwardly from a central region of the substrate 12. Each pair of the strips 14A, 14B and 16A, 16B is molded along with the central region of the substrate 12 in the injection molding apparatus 18, FIG. 3, to provide a row sequence along each of alternating male and female interlock elements.

The male-female elements 19, 20, respectively, on the first edge pair 14A, 14B and the male element 21 and female element 22 on the second edge pair 16A, 16B project generally perpendicularly from opposite respective sides of the substrate. Thus, as shown in FIG. 1, a first pair of elements 19, 20 on the edges 14A, 14B project upwardly or toward the plane of the lamina 11 whereas the second element pair 21, 22 on the edges 16A, 16B as shown in FIG. 2, project in an opposite direction toward the plane of the substrate 12 bottom surface, or downwardly when the tile 10 is installed on a horizontal surface.

The two pairs of somewhat resilient interlock elements 19, 20 and 21, 22 are substantially mirror images of one another so as to mate and thereby physically interlock with inverted, substantially identical and equally resilient pairs of edge interlocks on contiguous tiles without the use of adhesives.

As mentioned above, the substrate 12 may be composed of a granular matrix of PVC waste carpet scrap, various other thermoplastic matrices, utilizing for example, virgin PVC or other polymeric compositions of the polyolefin groups are also suitable materials for injection molding of the substrate and for the virtually simultaneous adhesion to the lamina 11. A typical substrate 12 has an average cross-sectional thickness of about 0.10 to 0.50 inches and preferably about 0.25 inch, and a top surface planar and devoid of protuberances. The substrate shape is generally determined by end user requirements and typically the substrate is molded to mount a square-shaped lamina 11 that simulates a variety of square-shaped floor products, such as square ceramic, stone or marble tiles or wood squares.

As disclosed in co-pending U.S. application Ser. No. 09/884,638, by Thomas E. Ricciardelli, filed Jun. 19, 2001 and assigned to the assignee of the present application, which is hereby incorporated by reference in its entirety herein,

The substrate component may also have an overall rectangular configuration with staggered ends to simulate the staggering of juxtaposed wood planks of a wood floor. In both of the embodiments disclosed in the patent applications, the lamina is preformed to cover, and thereby conceal, the downwardly projecting pair of interlock edges 16A, 16B with the interlock elements 21, 22 thereon, but leaves the edge strips 14a, 14B and their upwardly, projecting pair of interlock elements 19, 20 exposed to effect a mating engagement with substantially identical, inverted and downwardly facing pair of substrate interlocks on a substantially identical, superimposed interlock tile edges of a substantially identical tile.

Conversely, the concealed downwardly-facing interlock elements 21, 22 of the second pair of interlock edge strips 16A, 16B matingly engage underlying upwardly-projecting interlocks of other contiguous tiles (not shown). Because a pair of the lamina edges of both rectangular and square shapes are coextensive with the mating edge pairs of the contiguous tiles, the tiles typically will substantially abut one another to simulate linear grout lines or wood grooves.

The lamina 11 is preferably preformed of a sheet of plastic material and pre-cut to a desired size to cover the top surface of the substrate 12 contiguous to the edges thereof with the exception of first edge pair of the interlock strips 14A, 14B, which are exposed for subsequent interlocking purposes. The lamina 11 is typically composed of a thin, flexible sheet of polyvinyl chloride (PVC), or other polymeric material with suitable properties, having a thickness ranging from approximately 0.002 inch to 0.150 inch and more particularly from approximately 0.004 inch to 0.125 inch, and a weight of approximately 0.05 pounds per square inch to 0.50 pounds per square inch and preferably about 0.10 pounds per square inch. The lamina may be composed of materials other than plastic provided that thermal bonding with the substrate material can be effected in the injection molding apparatus 18. As will be apparent, the lamina is typically opaque and provided with a decorative appearance by color printing, sublimation or photographic techniques, which will be apparent to those skilled in the art.

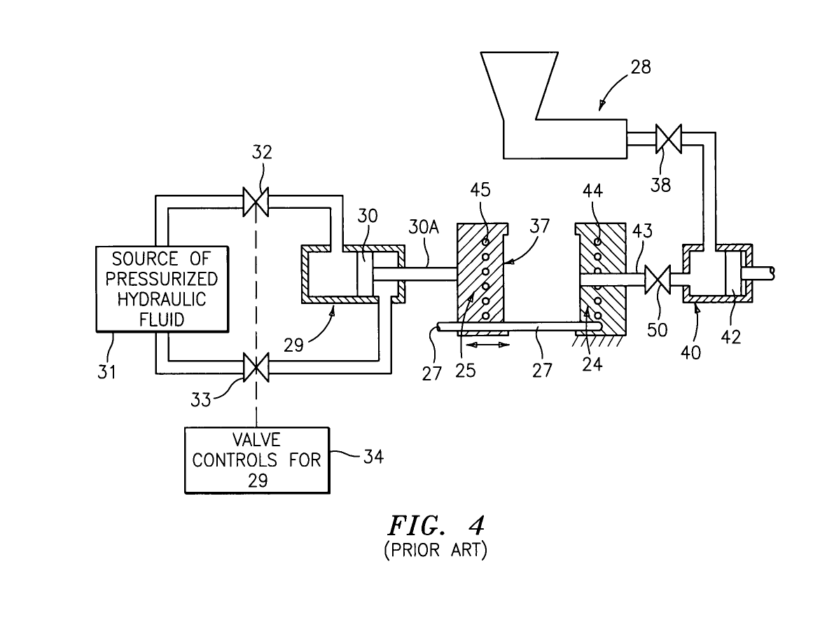

A prior art injection molding apparatus of the type disclosed in U.S. Pat. No. 6,303,318 is designated by the numeral 18 in FIG. 4, and is comprised of two complementary mold platens halves; a first fixed platen 24 with a mold cavity 36 and a second, movable platen 25 having a mold cavity 37 horizontally oppositely aligned with the cavity 36. At least one pair of horizontally aligned guide shafts 27 mount the platen 25 for horizontal movements under the drive control of a hydraulic piston 30 reciprocal in hydraulic cylinder 29; the piston 30 having piston rod 30A coupled to the platen 25. A source of hydraulic pressurized fluid 31 is alternatively applied to the piston 30 by alternative operation of flow control valves 32, 33 operated by a valve control 34. The valve control 34 controls the molding times that the platen 25 is driven towards and remains in facial abutment with the platen 24 as well as the intervals when the apparatus 18 is in its open and closed states. Typically the valve control 34 closes the mold for intervals ranging approximately from 10 to 120 seconds, depending on the time required to complete solidification of the tile body. In order to reduce solidification time, coolant is fed through tubes 44 and 45 of the platens 24 and 25, respectively, during mold closure.

The platen 24 has molten plastic injected into it from a heated extruder 28 under the control of a flow control valve 38. With a second control valve 50 driven to its open state, the piston 42 drives a predetermined quantity of the molten plastic in a heated hydraulic cylinder 40 sufficient to mold the tile through a conduit 43, and hence into the closed mold cavity where the tile is molded with through-edge type interlock elements thereon, as illustrated in U.S. Pat. No. 6,303,318.

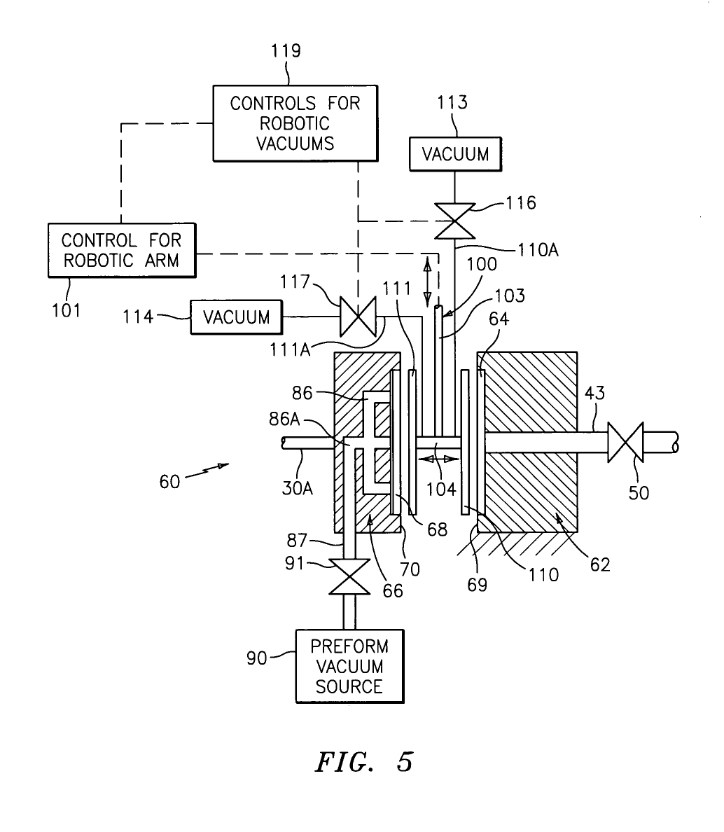

Having described a prior art injection molding process and apparatus, the process of this invention, as outlined by the flow diagrams of FIG. 3, is performed by the instant injection molding apparatus 60, depicted in FIG. 5, with redundant or non-pertinent parts shown in FIG. 4 deleted for clarity.

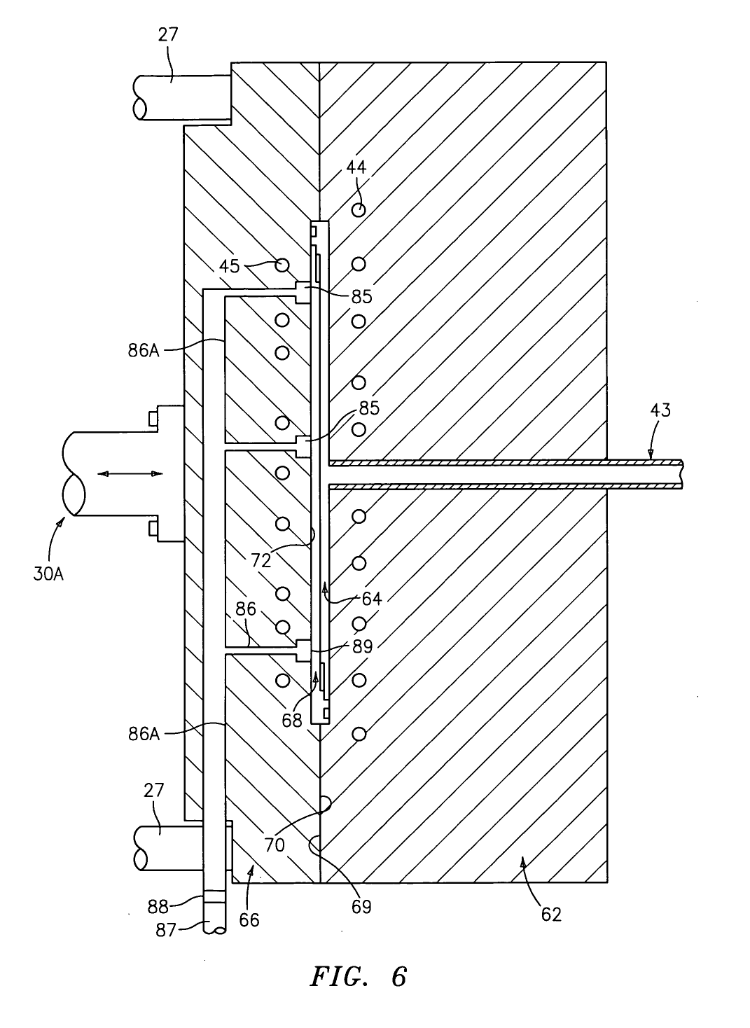

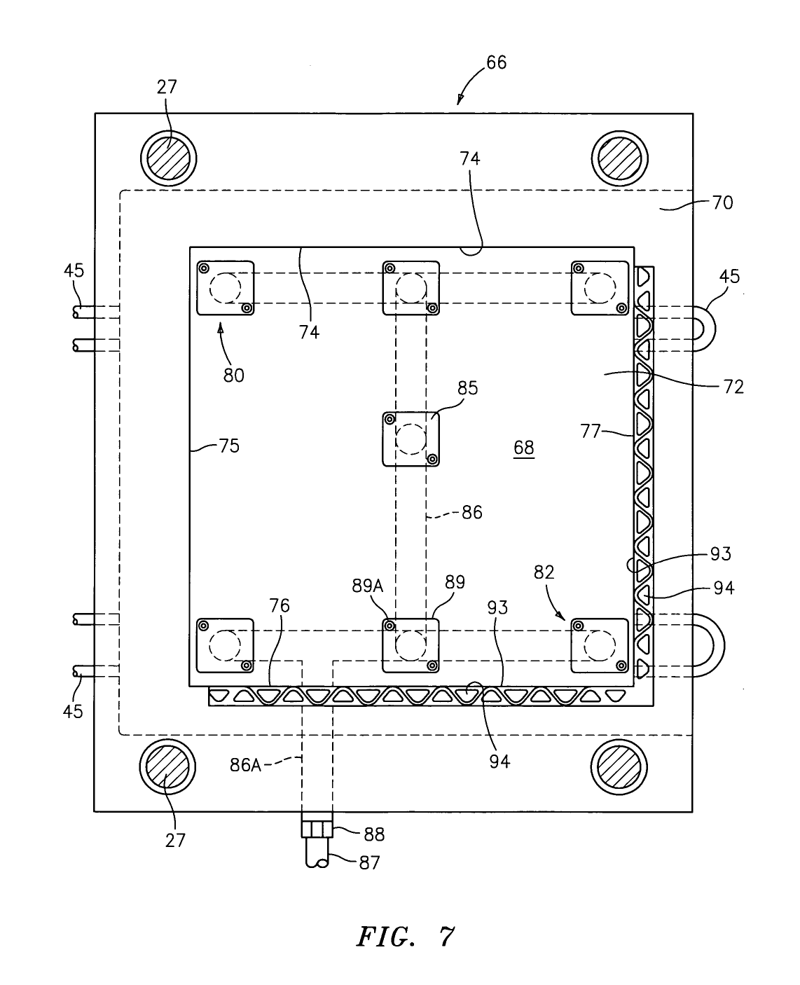

The apparatus 60 comprises a fixed platen 62 with a mold cavity 64 for molding the flat bottom portion 12, FIG. 2, of the tile 10 substrate from molten plastic injected under pressure of about 1000-2000 pounds per square inch from the conduit 43 controlled by the aforementioned valve 50. As illustrated in FIGS. 6 and 7, the reciprocal platen 66 has a mold cavity 68 in opposed horizontal alignment and in substantially vertical, parallel relationship with the cavity 64, thus providing a completely enclosed mold cavity, FIG. 5, when the substantially vertical planer face 70 of the platen 66 is driven by the rod 30A into abutment with the substantially parallel planar face 69 of the platen 62.

The cavity 68 is recessed into the face 70 of the platen 60 to a depth of typically twice the thickness of the lamina 11 and the lamina 11 is seated in the cavity with close edge tolerances of approximately 1 millimeter or less. Thus, for an exemplary lamina 11 of about 0.125 inch in thickness, the cavity has a depth of about 0.150 inches and the lamina 11 is placed with its top surface flat against the flat cavity base 72 and its bottom surface facing the cavity 64. The depth of cavity 64 is typically about twice that of the cavity 68, or in the exemplary case, about 0.300 inches. The depth differential offsets the parting line of the closed mold along the abutting interface of the platen faces 69, 70 from the interface between the bottom surface of the lamina 11 seated in the cavity 68 and the substrate material bonded thereto, which bonding occurs in the cavity 68 along a plane parallel to and inwardly of the edge 70 and the mold parting line, as shown in FIGS. 6, 8 and 9. This offset assures that the plane of thermal bonding is not coincident with the plane of the mold parting line and therefore not adversely affected by any adhesion failure along the plane of bonding.

As seen in FIGS. 6 and 7, extending perpendicularly outwardly from the cavity base 72 are first and second pairs of cavity sidewalls 74, 75 and 76, 77, respectively, having flat interior surfaces, the first pair of sidewalls 74, 75 intersecting at right angles to form a first interior cavity corner 80 and the second pair of sidewalls 76, 77 intersecting at right angles to form a second interior cavity corner 82 diagonally opposite the first corner 80. For seating laminas of square overall shape in the cavity 68 flush against the cavity base 72, the oppositely disposed interior corners are formed by intersecting adjacent walls of equal length, as illustrated, and longer than the length of a corresponding lamina edge by no more than approximately 0.001 inches to minimize flow of substrate material between the edges of the seated lamina and their adjacent cavity sidewalls.

Spaced around the periphery of the cavity base 72 and centrally thereof are a plurality of recessed suction cup elements 85, each having a flush screen or diaphragm 89 attached to the base 72 by screws 89A and commonly connected together by interior suction conduits 86 formed in the platen 66. The conduits 86 are coupled to a central conduit 86A that is connected to a flexible hose or conduit 87 by a fluid-tight coupling 88 that can move with the platen 66 and is coupled to a source of vacuum pressure 90, FIG. 5, by way of a control valve 91. The source 90 provides a vacuum of typically between 2-8 pounds per square inch, and preferably approximately 4 pounds per square inch, less than ambient pressure. This source 90 is, for example, a vacuum pump. The magnitude of the pressure is sufficient to hold the lamina flush against the cavity base 72 by suction through the screen 89.

To mold the first and second oppositely projecting pairs of interlock elements 14A, 14B and 16A, 16B, respectively, the corresponding first and second element forming strips on each respective platen are correspondingly formed with their interlock element patterns arranged to project in opposite directions on their respective platens. The right-angled element-forming strip for molding the first pair of downwardly facing interlock elements underlying the lamina edges are on the fixed platen face and the right-angled interlock element strip for molding the second pair of interlock elements of inverted-mirror image design and disposed laterally outwardly of their corresponding right angled lamina edges are on the movable platen face. To mold the tile 10 with its specific interlock edge structures, it is a preferred embodiment that the substrate material, that is typically black in color, does not flow around the edges of the lamina and adhere to the top surface edges of the lamina. The lamina is seated with only slight edge clearances of, for example, approximately between 0.0005 inch and 0.002 inch and more typically approximately 0.001 inch in the cavity of the movable platen and the corresponding interlock molding strips on the fixed platen are positioned laterally inwardly of the moveable platen cavity walls. Conversely, the second pair of right-angled cavity walls of the moveable platen are equally closely adjacent the inside edges of the two molding strips that form the second pair of the exterior interlocks so that molten substrate material injected against the bottom lamina surface 12 is impeded from flowing around the second pair of lamina edges and onto the top surface of the lamina during the injection molding process.

The interlock feature patterns are typically formed into the platen faces during the manufacture of the platens and may have the particular locking structure illustrated in FIGS. 1 and 2, other constructions, such as disclosed in U.S. patent application Ser. No. 09/884,638, or possibly other interlock designs, as appropriate for a laminated tile with interlocking edges.

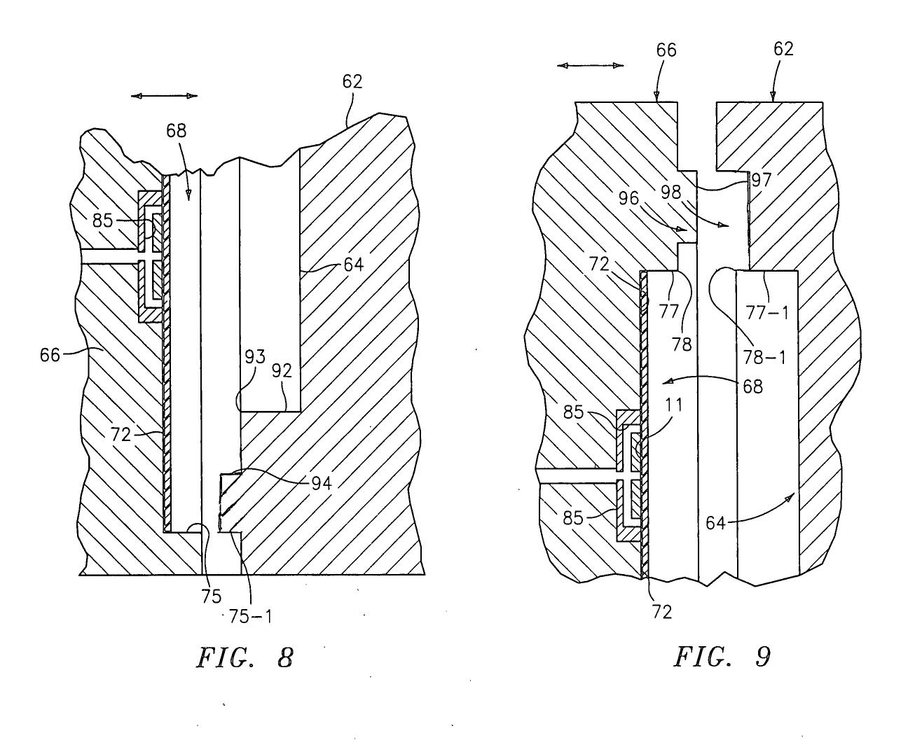

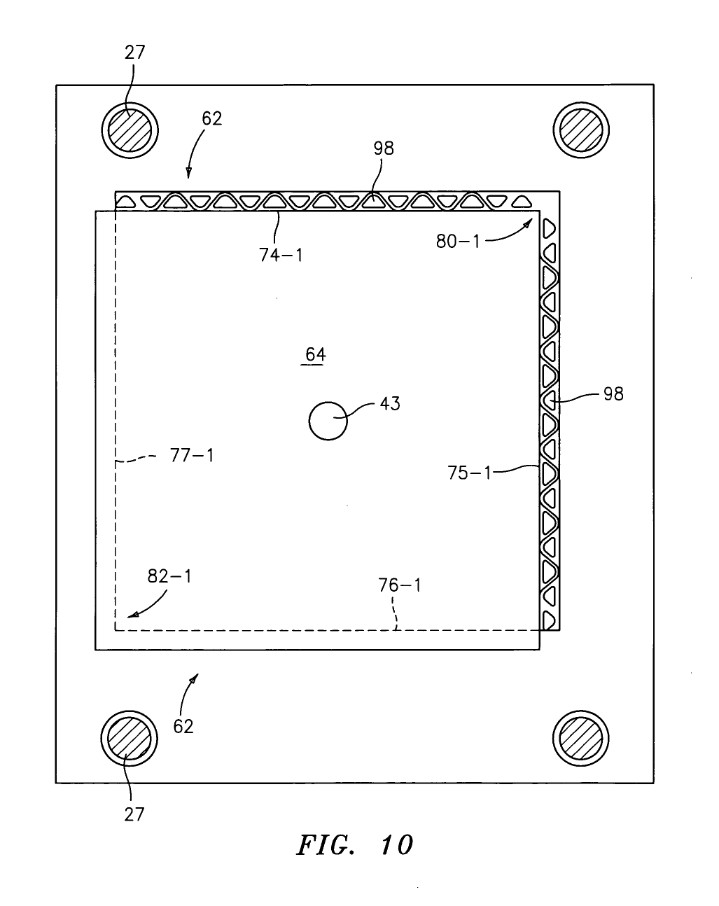

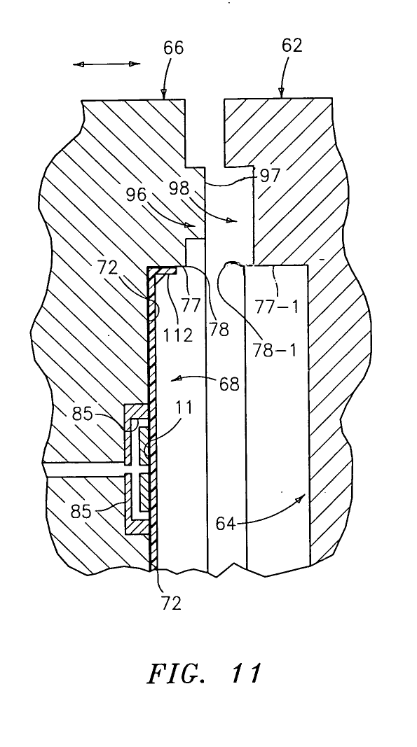

To mold the base interlock structure of the tile 10, the cavity sidewalls 76, 77, FIGS. 7 and 9, comprising the second pair of cavity sidewalls for the moveable platen 66 intersect a corresponding pair of edge strips 93 bearing interlock elements 94 thereon to form right-angled shoulder edges 78, FIG. 9, that are substantially oppositely aligned with right-angled edges 78-1 of sidewall 77-1 of platen 62. The depth of sidewalls 76, 77 also determines the vertical distance between the strips 93 and their interlock elements and the top surface of the substrate. The transverse space tolerances between the opposing sidewalls 77 and 77-1 and between the sidewall 76 and opposing sidewall 76-1, shown in FIG. 10, is minimized to prevent substrate flow around the lamina edges, as discussed above. The mold strips on the platen 66 bearing the male-female interlock forming elements 97 forms with a complementary oppositely aligned cavitated strip 98 on the platen 62, the exterior edge interlocks 14A, 14B of FIG. 1, that are not lamina-covered, project upwardly when the tile 10 is installed on a floor to interlock with mating downwardly projecting interlocks of contiguous tiles 10.

Conversely, and with reference to FIGS. 7, 8 and 10, the first pair of interlock strips 90 on the fixed platen 62 of overall rectangular shape in plan intersect at right angles opposite the corner region 80, FIG. 7, with the interior sidewalls 74, 75 of the movable platen 66 and form the downwardly facing and lamina-covered interlock edge elements 16A, 16B, FIG. 2. The element molding strips 90, FIG. 8, are stepped laterally outwardly from the cavity 64 sidewalls 92 and intersect those sidewalls to form right-angled shoulder edges 94 serving as the inside edges of the first pair of interlock strips and the right-angle stepped edges 35A, 35B, FIG. 2, between the second pair of substrate 12 edges and the adjoining interlock element strips 16A, 16B, respectively. The vertical distance between the shoulder edges 93 and the base of cavity 68 approximately accounting for lamina thickness determines the thickness of the edges 35A, 35B as well as the corresponding distance between the interlock strips and interlock molding elements 94 and the top surface of the tile substrate 12. This dimension is predetermined to ensure a sufficient interlock depth for strength and vertical spacing from the adjacent planar substrate top or bottom surfaces, as determined by design specifications. Conversely, the perpendicular distance between the edges 78-1, FIG. 9, and the base of cavity 64 determines the thickness of the bottom part of the substrate with the mold plate 62 parting line extending substantially parallel to the base of cavity 64 to intersect near the top of edges 78-1. As disclosed above, the depth of the cavity 64 is typically at least twice the depth of the cavity 68.

As discussed above, the first pair of interlock element molding strips is cast on the fixed platen 62 as mirror images of the second pair of interlock molding strips on the second platen 66 when viewed in plan, thereby producing the patterns of tile interlock elements illustrated in FIGS. 1 and 2. Because precision seating of the lamina in the cavity 68 is desirable as an alternative to manual placement, robotic machine controlled placement, described herein, is desirable.

Accordingly, a preferred embodiment of this invention employs a robotic arm 100, FIG. 5, conventionally articulated for movement in three spatial dimensions and operated by programmed control circuitry 101 to be selectively insertable in a vertical plane between the platens 62 and 66 after a molding cycle is completed and the platen 66 is retracted by rod 30 activation. The arm 100 is controlled by the control circuitry 101 to move in the horizontal plane in right and left directions, as viewed in FIG. 5, in predetermined sequences. Attached at right-angles to the free end of the arm 100 and extending outwardly thereof are hollow-ended right and left arm members 104, with depending vertically disposed right and left hand suction plates 110 and 111, respectively, attached and having surface apertures thereon, not shown. The plates 110, 111 are shaped in plan substantially as the cavities 64 and 68, respectively, but are of smaller size in plan so as to be accommodated completely within the cavity sidewalls. The apertures in the plates 110 and 111 are coupled via their respective arm members 104 to flexible air hoses 110A and 111B, respectively, to a pair of vacuum sources 113, 114, respectively, under the control of solenoid air valves 116, 117, which are electrically operated to sequentially open and apply vacuum pressure of about 5 PSI less than ambient pressure to their respective vacuum hoses 110A, 111A and hence to the apertured outer surfaces, not shown, of the plates 110, 111 by electrical signals transmitted from air valve timing control circuitry 119. The circuitry 119 typically is synchronized to, and under the control of, the arm control circuitry 101 to apply energizing control signals to open the valves 116, 117 in a selected sequence synchronized to the movement of the robotic arm 100.

With the platens 62 and 66 in the open position, the control circuitry 101 is energized to raise the arm 100 and thereby lift the plates 110, 111 from their depicted midway position between the platens 62, 66 to a location adjacent but outside of, the apparatus 60. The control circuitry 101 then activates the arm 100 to rotate counterclockwise, as viewed in FIG. 5, until the plate 111 is directly over the top-most lamina 11 stacked one on top of the other on the floor adjacent the apparatus, not shown, with the bottom surface 12 of each lamina facing upwardly. The vacuum control 119 energizes the valve 117 to open and apply vacuum pressure to the plate 111 aperture while the arm 100 lowers until the plate 111 contacts the bottom surface of the top-most lamina in the stack and applies a gripping force to the bottom surface thereof. The arm 100 raises the plate 111 with the gripped lamina, rotates in a clockwise direction until the plates 110, 111 are again vertical.

During the interim period the molding operation described herein is completed so that the molded tile 10 is retained in the cavity 64 and the platen 66 driven rearward by operation of the control 29 and cylinder 30 to open the mold and expose the laminated tile 10 in the cavity 64. The arm 100 is lowered by the control 101 until the plates 110 and 111 are again horizontally opposite the cavities 64 and 68, respectively, with the lamina 11 gripped by the plate 111 and positioned centrally of the cavity 68 and with the plate 110 positioned directly opposite the molded tile. The control circuitry 101 is then energized to cause the arm 100 to drive the plate 110 toward the right as viewed and into the cavity 64 until the plate contacts the tile in that cavity. The valve 116 is opened by a signal from the vacuum control circuit 119, and applies a vacuum pressure to the cavitated tile through the plate 110 apertures. The control circuitry 101 then activates the arm 100 to move until the preform lamina on the plate 111 is seated in the cavity 68 with its top surface against the cavity base 72.

The valve 91 is then energized to open and apply vacuum pressure from the source 90 to the cavity base 72 thereby retaining the lamina in the cavity 68. Substantially simultaneously, valve 117 is energized to close and remove vacuum pressure from the plate 111 and the lamina thereagainst and the arm 100 returned to its initial position, FIG. 5, with the previously molded tile 10 held by the plate 110.

The empty plate 111 and the plate 110 carrying the molded tile 10 are then moved upwardly and outwardly of the platens by the arm 100 to a prescribed floor area, not shown, adjacent the apparatus, whereupon the valve 116 is closed to release the vacuum and the tile carried by the plate. The valve 117 is opened to condition the plate 111 for picking up and transporting another lamina from the stack. The arm 100 may be rotated to stack the laminated tile prior to the release of the vacuum.

The valve 91 may also be selectively energized by signals from the vacuum control 119 so that vacuum is only applied to the cavity 68 during the time interval when the lamina is being held flush against the carrier base 72. Coolant is circulated through the coolant tube 45 to expedite adhesion between the lamina and the substrate during this interval. As the platens separate to release the tile, horizontal ejector pins, not shown, may be mounted inwardly of the cavity base 72 are cammed outwardly by platen movement to push the laminated tile outwardly toward the fixed cavity 64 where it resides until the suction plate 110 is moved opposite the cavity 64, whereupon similar ejector pins, also not shown, in the platen 62 are driven outwardly to push the laminated tile 10 outwardly to release it from the cavity 64 for pick-up by the plate 110.

While the apparatus 60 utilizes the movable platen as the mold half for the lamina, the arrangement could be reversed with the fixed platen constructed to seat the lamina and the moveable platen adapted to receive the molten substrate from the extruder 40, FIG. 4. As an alternative to the horizontal injection molding machine disclosed above, a vertical injection molding machine may be employed. In such case, the fixed platen is used as the lower platen constructed to seat the lamina.

Additionally, the substrate matrix may be a different color than the preformed lamina 11 and thus should the robotic arm 100 fail to center the lamina 11 in the cavity 68 with all of its edges sufficiently close to the cavity sidewalls 74, 75, 76 and 77, molten substrate may flow around the lamina edges and deposit substrate material on the top surface of the lamina. In order to inhibit this deposition, as illustrate in FIG. 11, the lamina 11 may be preformed with an integral edge rim 112 disposed at substantially right angles to the plane of the perform and extending outwardly of the cavity base 72 to be forced into contact with the cavity sidewalls by the robotic arm. The rim 112 provides a blocking surface to substrate flow around the lamina edges and after molding overlaps these edges to prevent substrate deposits on the top surface of the laminated tile 10A while not substantially interfering with the interlocking of contiguous tiles.

Thus, it will be understood by those skilled in the art that various modifications can be made without departing from the spirit and scope of the invention as defined in the following claims.

1. A method of making a composite floor tile comprised of a substantially flat, polymeric substrate having respective top and bottom surfaces and a preformed polymeric lamina having a bottom surface thereof laminated to the top surface of the substrate, comprising the steps of:
providing a two-platen injection molding machine with respective first and second aligned mold halves, the first half being fixedly mounted and the second half being movable toward and away from the first half;
forming an open-ended cavity in the first mold half with a predetermined substrate design shape;
forming a second open-ended cavity in the second mold half with sidewalls for seating the preformed lamina therein;
seating the preformed laminate in the second cavity with the bottom surface thereof facing the open end of the second cavity;
driving the second mold half against the first mold half for a predetermined period of time to form a mold cavity for molding the tile therewithin;
injecting molten polymeric material into the cavity and against the one surface of the preformed lamina under a pressure sufficient to fill the first cavity and at a temperature sufficient to thermally bond the molten substrate material to the bottom lamina surface in the second cavity; and
cooling the enclosed mold cavity to solidify the injected substrate material, whereby the substrate is molded and the lamina laminated thereto within substantially the same period of time.

2. The method as claimed in claim 1 and further comprising:
selecting a polymeric preformed lamina with a thickness of between 4×10⁻³ and 150×10⁻³ inch.

3. The method as claimed in claim 1, wherein said polymeric material is injected into the enclosed molding cavity at a temperature of between 140° C. and 300° C.

4. The method as claimed in claim 3, wherein the substrate plastic is injected into the first mold cavity half at a pressure of about 1,300 pounds per square inch, and wherein the mold cavity is closed with approximately 200 metric tons of force applied to the said second mold half.

5. The method as claimed in claim 4, wherein said predetermined time of mold closure ranges between 10 and 120 seconds.

6. The method as claimed in claim 1, and further comprising the step of applying vacuum pressure to the lamina in the second cavity to retain the lamina therein by suction.

7. The method as claimed in claim 6, wherein said lamina weighs about 0.10 pound per square inch, and wherein the vacuum pressure ranges between 3 and 5 pounds per square inch below atmospheric pressure for that weight of lamina.

8. The method as claimed in claim 7, wherein the vacuum pressure is applied to the corners and center portions of the top surface of the lamina from the bottom of the second cavity.

9. The method as claimed in claim 1, wherein the lamina has a decorative top surface, and wherein the step of seating the lamina includes placing the top surface thereof against the bottom of said second cavity, and selectively applying a suction pressure thereto.

10. An injection molding apparatus for making a modular interlocking composite plastic tile of a substrate with preformed planar plastic lamina laminated thereto, comprising:
first and second co-actable mold platens having substantially planar faces mounted in substantially parallel and opposed relationship,
means for fixedly mounting the first platen,
drive means for driving the second platen toward and away from said first fixed platen,
first and second open-ended mold cavities recessed in the faces of said first and second platens respectively for molding bottom and top portions of the tile substrate, respectively,
said cavities having open ends aligned substantially opposite one another for forming an enclosed mold when the face of said second platen is driven into abutting relationship with the face of said first platen by the said drive means,
each of said cavities having a substantially planar base substantially parallel to and inwardly of the planes of a corresponding one of the platen faces and first, second, third, and fourth substantially rectangular sidewalls adjoining corresponding first and second one of the cavity bases and extending substantially perpendicularly therefrom toward the plane of a corresponding platen,
said first and second sidewalls disposed at substantially right angles with respect to each other and intersecting to form a first interior corner region in each of their respective cavities, and said third and fourth sidewalls disposed at substantially right angles with respect to each other and intersecting to form a second transversely opposite interior corner region in each of their respective cavities,
a pair of first elongated interlock element molding strips each formed in the platen face of said first platen adjacent the first and second sidewalls, respectively, of said first platen, and positioned opposite said second cavity laterally inwardly of the first and second sidewalls thereof, respectively, for molding a first pair of substantially right-angled substrate edges and contiguous portions of the substrate in the first corner region of the first cavity,
a pair of second elongated interlock element molding strips each formed in the platen face of said second platen laterally outwardly of said third and fourth sidewalls respectively, of said second platen and projecting towards the plane of said first platen face for molding therebetween a second pair of substantially right-angled substrate edges and contiguous portions of the substrate laterally outwardly of said second corner region of said second cavity,
the first and second pairs of molding element strips having respective substantially identical, inverted patterns of edge interlock elements thereon,
the corner regions of said second cavity being spaced to receive and position plastic lamina in said second cavity in an orientation substantially parallel to the plane of said second mold platen, and conduit means coupled to said first platen and communicating with said first cavity for feeding molten substrate plastic for the tile substrate into said closed mold, whereby the substrate is molded and the lamina adhered thereto during substrate molding.

11. The apparatus as claimed in claim 10, wherein said second cavity is recessed to a depth dimension at least equal to the thickness of the lamina, and wherein the lamina lies upon the cavity base thereof, whereby the substrate plastic flows partially into said second cavity and into contact with the lamina.

12. The apparatus as claimed in claim 11, wherein said first corner region of said first cavity are joined by said first and second sidewalls of substantially equal length and width, whereby the substrate surface area underlying the lamina is substantially square and includes underlying interlocks molded into the substrate by said first pair of interlock strips on said first platen.

13. The apparatus as claimed in claim 12, wherein said second pair of interlock strips on said second platen extend laterally outwardly of said second cavity, whereby said second pair of interlock molding elements mold the second pattern of interlocks laterally outwardly of their corresponding lamina edge.

14. The apparatus as claimed in claims 12, wherein said first pair of interlock strips on said first platen include a sequence of male-female interlock elements positioned laterally inwardly of said first and second sidewalls of said second cavity, whereby said first pair of interlock strips mold the first pattern of interlock elements beneath their corresponding lamina edges.

15. The apparatus as claimed in claim 11, and further comprising, second conduit means communicating with said second cavity base, and means for applying a vacuum to said second conduit means, whereby the lamina is retained in the second cavity by suction.

16. The apparatus as claimed in claim 14, wherein said first and second pairs of interlock strips on each of said platens are spaced from one another adjacent their corresponding corner regions.

17. The apparatus as claimed in claim 16 wherein a first plurality of male interlock molding elements project from said mold interlock strips of said first pair toward said second pair, and wherein a second plurality of male interlock elements of said second pair project toward said first platen.

18. The apparatus as claimed in claim 14 and further comprising:
means for releasing the vacuum whereby said first cavity retains the substrate with the preformed lamina bonded thereto, and further comprising,
means for operating said drive means to open said mold halves for removing the floor tile from said first cavity.

19. The apparatus as claimed in claim 10, and further comprising:
robotic means including a movable arm operative while the platens are open for withdrawing a molded composite tile from said first cavity and for placing the next lamina in said second cavity.

20. The apparatus as claimed in claim 19, wherein the robotic arm comprises first and second substantially parallel, transversely spaced-apart suction pads for conveying the composite tile and the lamina respectively.

21. The apparatus as claimed in claim 20, wherein said pads are coupled to a source of vacuum pressure, and
valve means coupled to said source for selectively applying vacuum to said pads.

22. The apparatus as claimed in claim 21, wherein said robotic arm is movable in both parallel and perpendicular directions relative to the movement direction of said second platen.
